(19) United States
(12) Patent Application Publication
(10) Pub. No.: US 2012/0276411 A1
(43) Pub. Date: Nov. 1, 2012

(54) Coating Composition

(75) Inventor: Eddie Neesom, Filey (GB)

(73) Assignee: HUNPRENCO PRECISION ENGINEERS LIMITED, Filey, Yorkshire (GB)

(21) Appl. No.: 13/381,506

(22) PCT Filed: Jun. 2, 2010
(86) PCT No.: PCT/GB10/50930

§ 371 Date: Mar. 21, 2012

(30) Foreign Application Priority Data
Jun. 30, 2009 (GB) 0911201.2

(51) Int. Cl. C22C 30/00; B32B 33/00; C22C 19/07; C23C 4/08; C22C 27/04; B32B 15/01; C03B 11/06

(52) U.S. Cl. 428/665; 428/656; 65/374.12; 427/456; 420/431; 420/440; 420/585

(57) ABSTRACT

A coating composition for coating a substrate, the coating composition comprising: Carbon in an amount of between about 1.5 and 3 wt %; Chromium in an amount of between about 10 and 15 wt %; Iron in an amount of between about 1 and 3 wt %; Nickel in an amount of less than about 15 wt %; 10 Silicon in an amount of between about 1 to 3 wt % Tungsten in an amount of between about 10 to 55 wt % with the balance of wt % being Cobalt.

The present invention relates to coating compositions, particularly to a coating composition for coating a metal substrate for use in the glass working industry. The invention also extends to an article coated with the coating composition, particularly to a plunger for use in the glass working industry having the coating composition fused onto a surface thereof.

The manipulation of glass into required shapes and sizes has been practiced for centuries and requires the glass to be heated to a working temperature, at which point the viscosity of the glass is sufficiently low that it can be manipulated. The working temperature of the glass depends on the type of glass used, but is, in general, in the region of about 500 to 600° C.

In the modern era, the shaping of glass into containers such as jars and bottles is undertaken in large scale factory operations. The two main ways of forming glass containers in a factory operation are known as the “press and blow” method and the “blow and blow” method. In both cases, glass above its working temperature is forced into a mould. In the press and blow method, glass is first pressed into a mould using a plunger to make a partly formed container, then gas a is used to blow the partly formed container into a finished container.

The plungers used in the press and blow technique are generally made from a metal substrate (usually cast iron or steel), coated with a surface coating material. The surface coating material is designed to withstand the high temperatures experienced in glass processing, while also providing acceptable lubrication and abrasion qualities.

Known surface coating materials used for coating such plungers are often based on a tungsten carbide material having a high nickel content. However, such materials can display problems at the high working temperatures, which can lead to problems in the formed glass container such as nickel voids. Such containers have to be scrapped and remade. Further, there is a desire in the industry to move to high velocity machines for forming the glass containers, which will require higher operating temperatures still, thus exacerbating the problems experienced with known coating materials.

It is an object of aspects of the present invention to provide an improved coating material for plungers used in the glass working industry.

According to a first aspect of the present invention there is provided a coating composition for coating a substrate, the coating composition comprising:
Boron in an amount of between about 1 and 2.5 wt %;
Carbon in an amount of between about 1.5 and 3 wt %;
Chromium in an amount of between about 10 and 15 wt %;
Iron in an amount of between about 1 and 3 wt %;
Nickel in an amount of less than about 15 wt %;
Silicon in an amount of between about 1 to 3 wt %
Tungsten in an amount of between about 10 to 55 wt %
with the balance of wt % being Cobalt.

Advantageously, a coating having the above mentioned components has a low amount of nickel, and thus avoids the problems associated with the prior art. However, it has been surprisingly found that such a composition has excellent heat resistance, lubrication and abrasion properties, thus providing a superior composition to prior art compositions.

Preferably, the substrate is a metal substrate, preferably cast iron or steel.

Preferably, the coating composition is a fusible composition.

By the term “fusible composition” it is meant a composition that is capable under appropriate conditions of temperature to melt and fuse together to form, after subsequent cooling, a single solid entity. This single solid entity may be referred to as a fused material.

Preferably, boron is present in the coating composition in an amount of between about 1.5 and 2.0 wt %

Preferably, carbon is present in the coating composition in an amount of between about 2 and 2.75 wt %

Preferably, chromium is present in the coating composition in an amount of between about 11 and 13 wt %

Preferably, iron is present in the coating composition in an amount of between about 1.75 and 2.5 wt %

Preferably, nickel is present in the coating composition in an amount of between about 8 and 15 wt %, more preferably between about 10 and 13 wt %.

Preferably, silicon is present in the coating composition in an amount of between about 1.5 and 2.25 wt %

Preferably, tungsten is present in the coating composition in an amount of between about 15 and 50 wt %

Preferably, the cobalt is present in the coating composition in an amount of between about 10 to 60 wt %, more preferably between about 14.5 to 57.25 wt %. Preferably, the cobalt is present in the coating composition in an amount of between about 20 to 40 wt %.

Preferably, the coating composition is a powder.

According to a further aspect of the present invention there is provided an article, the article comprising a carrier portion having a coating thereon, the coating being formed from a coating composition, the coating composition comprising:
Boron in an amount of between about 1 and 2.5 wt %;
Carbon in an amount of between about 1.5 and 3 wt %;
Chromium in an amount of between about 10 and 15 wt %;
Iron in an amount of between about 1 and 3 wt %;
Nickel in an amount of less than about 15 wt %;
Silicon in an amount of between about 1 to 3 wt %
Tungsten in an amount of between about 10 to 55 wt %
with the balance of wt % being Cobalt.

Preferably, the carrier portion comprises metal, preferably cast iron or steel. The carrier portion may be a cast iron or steel rod.

Preferably, the article is a plunger for use in the glass working industry.

According to a further aspect of the present invention there is provided a plunger for use in the glass working industry, the plunger comprising a metal carrier portion having a coating fused thereon, the coating being formed from a coating composition, the coating composition comprising:
Boron in an amount of between about 1 and 2.5 wt %;
Carbon in an amount of between about 1.5 and 3 wt %;
Chromium in an amount of between about 10 and 15 wt %;
Iron in an amount of between about 1 and 3 wt %;
Nickel in an amount of less than about 15 wt %;
Silicon in an amount of between about 1 to 3 wt %
Tungsten in an amount of between about 10 to 55 wt %
with the balance of wt % being Cobalt.

According to a further aspect of the present invention there is provided a method of forming an article, the method comprising fusing a coating composition onto a carrier portion, the coating composition comprising:
Boron in an amount of between about 1 and 2.5 wt %;
Carbon in an amount of between about 1.5 and 3 wt %;
Chromium in an amount of between about 10 and 15 wt %;
Iron in an amount of between about 1 and 3 wt %;
Nickel in an amount of less than about 15 wt %;
Silicon in an amount of between about 1 to 3 wt %
Tungsten in an amount of between about 10 to 55 wt %
with the balance of wt % being Cobalt.

Preferably, the coating composition is fused onto the carrier portion by High Velocity Oxy Fuel (HVOF) welding.

All of the features contained herein may be combined with any of the above aspects and in any combination.

For a better understanding of the invention, and to show how embodiments of the same may be carried into effect, reference will now be made, by way of example, to the following drawing and example formulations.

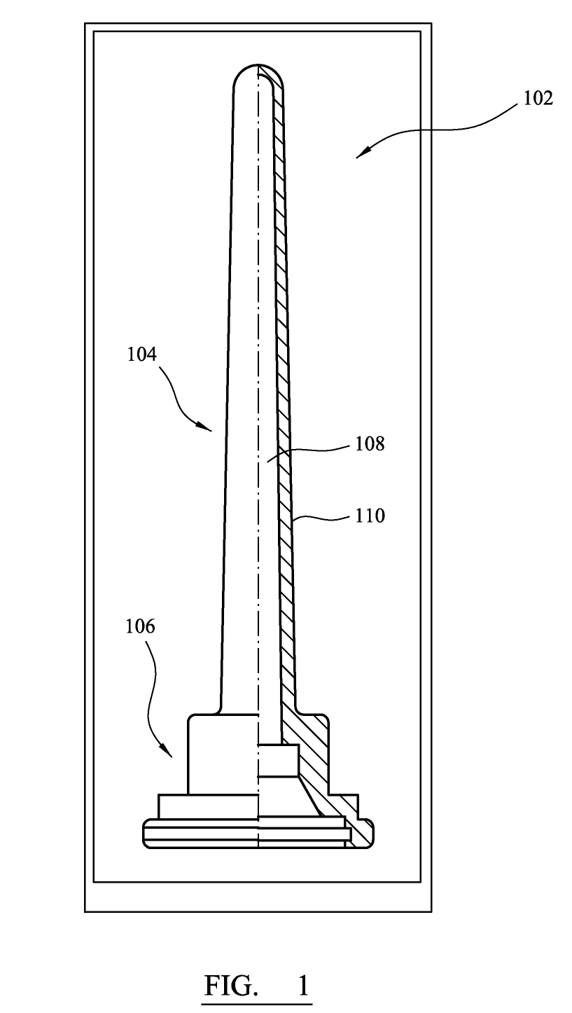

FIG. 1 shows a partial cutaway view of a plunger for use in the glass working industry having a fusible material composition of the present invention fused thereon.

FIG. 1 shows a plunger 102 having a slightly tapered elongate shaft member 104 and a base portion 106, which is circular in section. The plunger 102 comprises a steel core 108 having a coating material 110 fused thereon. The coating material is applied at a thickness of 0.3 to 0.8 mm. The coating material is a fusible composition of the present invention and is applied to the steel core by HVOF welding as is known in the art.

The plunger is used in the glass working industry as discussed above in the preamble.

However, the coating material, being a fused fusible composition of the invention, offers advantages over the prior art in terms of heat resistance, abrasion resistance and lubrication.

### EXAMPLES

A plunger manufactured from AISI-SAE 8620 Heat Treatable Low Alloy (HTLA) steel had a fusible material fused thereon using High Velocity Oxy Fuel (HVOF) welding.

The fusible material was applied to the substrate plunger and the coating alloy was tested using gravimetric, volumetric, IR combustion and inductively coupled plasma mass spectrometry techniques and was found to have the following composition:
Boron: 1.97 wt %
Carbon: 2.58 wt %
Cobalt: 33.23 wt %
Chromium: 11.68 wt %
Iron: 1.82 wt %
Nickel: 13.00 wt %
Silicon: 1.72 wt %
Tungsten: 34.00 wt %

The plunger having the above mentioned coating composition fused thereon is able to work at higher temperatures than prior art plungers, at higher speeds than prior art plungers and will thus give a higher yield and cost effectiveness in view of the higher speed and higher temperature.

Furthermore, the plunger coated with the coating composition as discussed above avoids the problems associated with Nickel based coating materials, such as nickel voids in the glass.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A coating composition for coating a substrate, the coating composition comprising:
Boron in an amount of between about 1 and 2.5 wt %;
Carbon in an amount of between about 1.5 and 3 wt %;
Chromium in an amount of between about 10 and 15 wt %;
Iron in an amount of between about 1 and 3 wt %;
Nickel in an amount of less than about 15 wt %;
Silicon in an amount of between about 1 to 3 wt %;
Tungsten in an amount of between about 10 to 55 wt %; and
with the balance of wt % being Cobalt.

2. A coating composition according to claim 1, wherein the coating composition is a fusible composition.

3. A coating composition according to claim 1, wherein boron is present in the coating composition in an amount of between about 1.5 and 2.0 wt %.

4. A coating composition according to claim 1, wherein carbon is present in the coating composition in an amount of between about 2 and 2.75 wt %.

5. A coating composition according to claim 1, wherein chromium is present in the coating composition in an amount of between about 11 and 13 wt %.

6. A coating composition according to claim 1, wherein iron is present in the coating composition in an amount of between about 1.75 and 2.5 wt %.

7. A coating composition according to claim 1, wherein nickel is present in the coating composition in an amount of between about 8 and 15 wt %.

8. A coating composition according to claim 1, wherein silicon is present in the coating composition in an amount of between about 1.5 and 2.25 wt %.

9. A coating composition according to claim 1, wherein tungsten is present in the coating composition in an amount of between about 15 and 50 wt %.

10. A coating composition according to claim 1, wherein the cobalt is present in the coating composition in an amount of between about 10 to 60 wt %.

11. A coating composition according to claim 1, wherein the coating composition is a powder.

12. An article, the article comprising a carrier portion having a coating thereon, the coating being formed from a coating composition, the coating composition comprising:
Boron in an amount of between about 1 and 2.5 wt %;
Carbon in an amount of between about 1.5 and 3 wt %;
Chromium in an amount of between about 10 and 15 wt %;
Iron in an amount of between about 1 and 3 wt %;
Nickel in an amount of less than about 15 wt %;
Silicon in an amount of between about 1 to 3 wt %;
Tungsten in an amount of between about 10 to 55 wt %; and
with the balance of wt % being Cobalt.

13. An article according to claim 12, wherein the carrier portion comprises metal.

14. A plunger for use in the glass working industry, the plunger comprising a metal carrier portion having a coating fused thereon, the coating being formed from a coating composition, the coating composition comprising:
Boron in an amount of between about 1 and 2.5 wt %;
Carbon in an amount of between about 1.5 and 3 wt %;
Chromium in an amount of between about 10 and 15 wt %;
Iron in an amount of between about 1 and 3 wt %;
Nickel in an amount of less than about 15 wt %;
Silicon in an amount of between about 1 to 3 wt %;
Tungsten in an amount of between about 10 to 55 wt %; and
with the balance of wt % being Cobalt.

15. A method of forming an article, the method comprising fusing a coating composition onto a carrier portion, the coating composition comprising:
Boron in an amount of between about 1 and 2.5 wt %;
Carbon in an amount of between about 1.5 and 3 wt %;
Chromium in an amount of between about 10 and 15 wt %;
Iron in an amount of between about 1 and 3 wt %;
Nickel in an amount of less than about 15 wt %;
Silicon in an amount of between about 1 to 3 wt %;
Tungsten in an amount of between about 10 to 55 wt %; and
with the balance of wt % being Cobalt.

16. A method according to claim 15, wherein the coating composition is fused onto the carrier portion by High Velocity Oxy Fuel (HVOF) welding.

17. A coating composition according to claim 1, wherein the coating composition comprises:
Boron in an amount of between about 1.5 and 2.0 wt %
Carbon in an amount of between about 2 and 2.75 wt %;
Chromium in an amount of between about 11 and 13 wt %;
Iron in an amount of between about 1.75 and 2.5 wt %; and
Nickel in an amount of between about 8 and 15 wt %.

18. A coating composition according to claim 17, wherein the silicon is present in the coating composition in an amount of between about 1.5 and 2.25 wt %.

19. A coating composition according to claim 18, wherein the tungsten is present in the coating composition in an amount of between about 15 and 50 wt %.

20. A coating composition according to claim 19, wherein the cobalt is present in the coating composition in an amount of between about 10 to 60 wt %.
